(19) United States
(12) Patent Application Publication
(10) Pub. No.: US 2017/0101005 A1
(43) Pub. Date: Apr. 13, 2017

(54) Drive Unit for an Industrial Transport Vehicle

(71) Applicant: Kordel Antriebstechnik GmbH, Dulmen (DE)

(72) Inventor: Josef Raue, Dulmen (DE)

(21) Appl. No.: 15/289,976

(22) Filed: Oct. 11, 2016

(30) Foreign Application Priority Data
Oct. 13, 2015 (DE) 102015013141.9

(51) Int. Cl. B60K 17/30; B62D 9/00; B60K 7/00; F16H 1/20; F16H 1/14; F16H 57/038

(52) U.S. Cl. CPC B60K 17/303; F16H 1/14; F16H 57/038; B60K 7/0007; F16H 1/203; B62D 9/00; B60K 2007/0084

(57) ABSTRACT

A drive unit, in particular for an industrial transport vehicle, is at least comprised of a gearbox with at least one gear stage, a drive motor and a running wheel. To minimize the costs when there are substantially greater loads on the running wheel, there are provisions in accordance with the invention for the running wheel to be directly connected to a bevel gear on the output side, which is supported by a first bearing element for accommodating the load and by a second bearing element that serves to provide stabilization and that is supported in the gearbox . The first bearing element bears all of the loads here, whereas the second bearing element with substantially smaller dimensions merely has to cushion tilting forces that arise.

### CROSS REFERENCE TO RELATED APPLICATIONS

This application claims the priority of DE 102015013141.9 filed on Oct. 13, 2015; this application is incorporated by reference herein in its entirety.

### BACKGROUND

The invention relates to a drive unit, in particular for an industrial transport vehicle, at least comprising a gearbox with at least one gear stage, a drive motor and a running wheel.

Generic drive units are required for industrial transport vehicles and serve to propel the industrial transport vehicle and to provide steering mobility. The drive units are connected to the industrial transport vehicle via a turntable bearing in connection with this and can perform a 360-degree movement, so steering of the industrial transport vehicles is possible in a very tight space. The drive units have to fulfill strict requirements with regard to loads in connection with this that result from the vehicle weight and its added load. Furthermore, high driving forces are transferred via these drive units to the running wheel or, if applicable, to twin running wheels for the propulsion.

The structure of a drive unit of this type is known, as an example, from DE-PS 31 33 027. This prior art discloses a single-wheel drivetrain for an industrial transport vehicle in which, in a two-stage transmission design, a pinion is arranged on the electric motor shaft that drives a spur gear. The torque is transferred via a drive shaft, which extends from the spur gear to a bevel gear, to an outgoing bevel gear that is directly connected to a running wheel carrier and a running wheel as a rule. The overall structure of the single-wheel drivetrain is dimensioned in accordance with the housing design and the two gear stages for the transfer of high torques and the accommodation of corresponding loads of several tons.

A single-wheel drivetrain is likewise known from EP 1 285 803 A1 that has a special construction variant, and, in fact, the gearwheel on the outgoing side is supported on a support element of the housing coaxially fixed in the interior. Support is provided in this case via two rolling bearings arranged as a pair. The entire load that is to be accommodated by the running wheel in connection with this is transferred in this special case via the inner races of the rolling bearings to the gearbox.

This solution for a single-wheel drivetrain, or drive unit as the case may be, has very much proven its worth, but is complex and more cost-intensive due to the structure with the bearing element that was chosen.

### SUMMARY

The invention relates to a drive unit 1, in particular for an industrial transport vehicle, at least comprising a gearbox 4 with at least one gear stage 2, 3, a drive motor and a running wheel 14. To minimize the costs when there are substantially greater loads on the running wheel 14, there are provisions in accordance with the invention for the running wheel 14 to be directly connected to a bevel gear 12 on the output side, which is supported by a first bearing element 15 for accommodating the load and by a second bearing element 23 that serves to provide stabilization and that is supported in the gearbox 4. The first bearing element 15 bears all of the loads here, whereas the second bearing element 23 with substantially smaller dimensions merely has to cushion tilting forces that arise.

### DETAILED DESCRIPTION

The instant invention is based on the objective of showing a new drive unit for an industrial transport vehicle that makes more cost-efficient production possible with the same or improved load-bearing capacity.

To solve the problem in accordance with the invention, there are provisions for the running wheel to be directly connected to bevel gear on the output side, which passes the load to be supported via a first bearing element for accommodating the load into the gearbox through the outer bearing race and which is supported by a second bearing element for stabilization with respect to the gearbox. Further advantageous design forms of the invention follow from the subordinate claims.

At least one, preferably several, bearing elements are required to achieve an increase in the load-bearing capability of the drive unit and to transfer the forces from the running wheel through the outer bearing race into the gearbox of the industrial transport vehicle. The necessity of appropriately dimensioning a support element that is to be utilized and simultaneously using a bearing element that is capable of withstanding the stress also exist in connection with this when there is an increase in the load-bearing capacity of the running wheel. The production costs increase significantly here as soon as more than one bearing element is required. The instant invention assumes that the loads that arise will only be accommodated by a first bearing element, and a second, considerably smaller bearing element will only be used to provide stabilization with respect to the gearbox. Stabilization means in this case that the arrangement comprised of the running wheel, the running wheel carrier and the bevel gear is to be supported in such a way that tilting forces that arise can be passed into the gearbox without further ado, and the running stability and lateral guidance of the running wheel will therefore be ensured. A special advantage also arises in connection with this that only a single large bearing element is required that is intended to accommodate the load and that can be correspondingly dimensioned, whereas, on the other hand, the second bearing element is not used to accommodate the main load and is merely used for stabilization. The second bearing element can correspondingly have small dimensions because of that, and a cost advantage is therefore achieved.

Furthermore, there are provisions to directly connect the running wheel to the bevel gear on the output side to reduce the number of components of the drive unit. Large torques are transferred to the running wheel via the bevel gear without an additional shaft being required.

There are provisions in the embodiment of the invention for the gearbox to have a rear housing wall that is diametrically turned away from the running wheel and that is designed to be completely closed and formed in a single piece, or that the gearbox has a rear housing wall diametrically turned away from the running wheel, wherein the gearbox is closed by the rear housing wall and a cap. The housing can consequently likewise be manufactured in a cost-effective way, and this makes improved assembly and disassembly of the overall drive unit possible. The lower gearbox components regarding the bevel gear can be installed in the gearbox via a housing cover without any adverse effects in this design. Moreover, the required sealing measures for the gearbox can be reduced to a minimum; a sealing ring is preferably arranged at the height of the first bearing element and the other gearbox components can be dismantled in reverse order after the sealing element and the opposing cover are removed, so it is possible to replace defective parts at any time in a simple manner. In particular, no gearbox disassembly is required at all to replace the sealing element, which is subject to wear and tear over the service life of the gearbox. The sealing element can be directly disassembled after the running wheel is taken off and the protective ring is removed without having to disassemble the gearing including the rolling bearings. On top of that, a seal with the sealing element is sufficient and there are no costs for other sealing elements.

In a first design variant, there are provisions for the bevel gear to have a support element, which is intended to be used to accommodate the second bearing element, that is formed in one piece and that is in the direction of the rear housing wall. Alternatively, the bevel gear can have a recess that is open in the direction of the housing wall. If the bevel gear is provided with a support element, the interior of the gearbox will be equipped with a pot-shaped recess into which the bevel gear projects with its support element. If the bevel gear is equipped with a recess, the gearbox, in contrast, can have a support element formed in the direction of the running wheel that is once again provided to accommodate the second bearing element. In both cases, assembly and disassembly are very easy; on the one hand, only a few individual parts are required and, on the other hand, they can be installed or removed from one side after the sealing element is removed. The support elements that are used, assigned to a choice of the gearbox or the bevel gear, make the arrangement of the second bearing element possible; it is in fact arranged in a coaxial manner with respect to the bearing element, but at a lateral offset to it so that the tilting moments that arise can be cushioned.

In a further embodiment of the invention, there are provisions for the first bearing element to have a coaxially internal arrangement with respect to the running wheel and to be within the width of the running wheel; a reliable transfer of the load forces that arise into the gearbox is made possible because of that. The first bearing element has an inner bearing shell and an outer bearing shell here in which the rotating bearing elements are located. Alternatively, there is a possibility for the first bearing element to have an external bearing shell, whereas the inner bearing shell is formed by a recess of the bevel gear. The costs of the first bearing element can be further reduced via the design of the inner bearing shell on the periphery of the bevel gear. The inner bearing shell and the outer bearing shell of the first bearing element can be designed so as to be capable of axial movement and can be fixed in place with a retaining ring in the gearbox. This possibility is taken into consideration when only one bearing shell is used and the second bearing shell is available through an external surface of the bevel gear. Otherwise, the first bearing element is fixed in place with a retaining ring in the gearbox.

The position of the second bearing element can be chosen in dependence upon the embodiment of the gearbox and the bevel gear; it will be mounted on a support element that will be formed in any case. According to a first embodiment, the second bearing element can be mounted on the support element of the bevel gear and mounted in a recess of the gearbox. Alternatively, the second bearing element can be mounted on the support element of the gearbox and mounted in a recess of the bevel gear. Both solutions are conceivable and will reduce the manufacturing costs because the second bearing elements that are used are not exposed to high levels of stress.

In the various embodiments of the gearbox, the bevel gear is designed in the form of a ring gear as a rule, for instance when the support element is formed on the interior of the gearbox. As an alternative, the bevel gear can be designed to transfer the load forces as a solid web and simultaneously make the support element available for the second bearing element with an axial extension, whereas, on the other hand, the gearbox is provided with a corresponding recess into which the support element with the second bearing element projects.

The overall drive unit is comprised in this case of a first gear stage, made up of a driving pinion of the drive motor and a driven spur gear, whereas the second gear stage is comprised of a drive shaft with a spiral gearing and the bevel gear. The drive shaft itself can be supported in the gearbox via further bearing elements; a coaxial-sided arrangement of bearing elements at the end of the drive shaft has proven itself.

Furthermore, the overall drive unit is connected via a turntable bearing to the industrial transport vehicle; the gearbox is directly connected to the inner ring of the turntable bearing or a horizontal, upper housing cover is already designed in the form of an inner ring of the turntable bearing.

There are provisions in a preferred embodiment for the running wheel to be directly connected to a bevel gear on the output side, which meshes via gearing with the drive shaft, which passes the load to be supported via a first bearing element for accommodating the load into the gearbox through the outer bearing race and which is supported by a second bearing element for stabilization with respect to the gearbox.

The advantage of the instant invention is, on the one hand, that the load forces that arise can be reliably cushioned and an appropriately dimensioned first bearing element is sufficient for this because of the use of two bearing elements that are arranged at a spacing, but in a coaxial fashion, with regard to one another, whereas, on the other hand, a reduction in costs is achieved via the use of a second bearing element that only serves to accommodate tilting forces and that can therefore have correspondingly smaller dimensions. Furthermore, the overall structure of the drive unit is advantageous because the rear wall of the gearbox is manufactured as one self-contained piece, and the individual components of the gear stages can consequently be installed in the drive unit and removed once again in a very easy manner. It is also advantageous in this special case that a sealing element, which is additionally shielded by the running wheel carrier in operation, seals the overall gearbox, and all of the internal components of the drive unit are accessible after the sealing element is removed.

### BRIEF DESCRIPTION OF THE DRAWINGS

The invention will be explained once again below with the aid of the figures. The drawings show the following:

FIG. 1 shows a first embodiment in a cutaway side view of a drive unit,

FIG. 2 shows a second embodiment of a drive unit in a cutaway side view and

FIG. 3 shows a third embodiment of a drive unit in a cutaway side view.

### DETAILED DESCRIPTION OF THE PREFERRED EMBODIMENTS

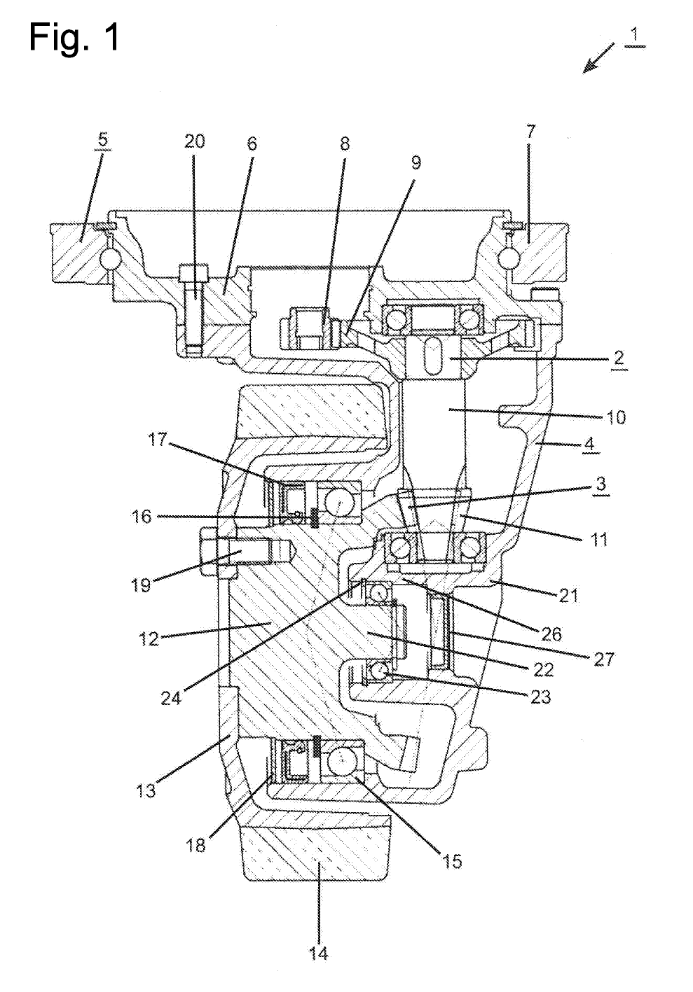

FIG. 1 shows a drive unit 1 in a cutaway view that has a first gear stage 2 and a second gear stage 3. The two gear stages 2, 3 are mounted in a gearbox 4, which can be connected via a turntable bearing 5 to an industrial transport vehicle that is not shown. In the example that is shown, the housing cover of the gearbox 4 is already designed as an inner ring 6 of the turntable bearing and is accommodated by the outer ring 7 of the turntable bearing. The inner ring 6 of the turntable bearing simultaneously serves here to accommodate an electric motor, not shown, which forms the first gear stage 2 with the aid of a pinion 8 and a spur gear 9. The transfer of the torque via a spiral gearing 11 to a bevel gear 12 takes place through a shaft 10. Both the pinion 8 and the spur gear 9 mesh with one another, and the spiral gearing 11 likewise meshes with the bevel gear 12. The bevel gear 12 further serves to fasten a running wheel carrier 13 to a running wheel 14. Because of the turntable bearing 5, the gearbox 4 with the gear stages 2, 3 can be swiveled over an angle range of 360 degrees, so not just the propulsion, but also the steering of an industrial transport vehicle can be carried out with the aid of the drive unit 1 and the running wheel 14.

The running wheel 14 with the running wheel carrier 13 and the bevel gear 12 are supported with a first bearing element 15 to accommodate a payload of the industrial transport vehicle of several tons. This bearing element 15 serves to accommodate all of the loads that can arise from the transport vehicle's own weight and the transport of goods by the industrial transport vehicles. The bearing element 15 is fixed in place here in the gearbox 4 with a retaining ring 16 and is additionally sealed towards the outside by a sealing element 17; the sealing element 17 seals the entire gearbox 4. The sealing element 17 is further protected against damage and contamination with a protective ring 18 that can be pressed in. The running wheel carrier 13 and the bevel gear 12 are connected with several screw bolts 19, just as the housing cover 6 is screwed together with the gearbox 4 via further screw bolts 20.

The special feature of this drive unit 1 is that the bevel gear 12 is essentially comprised of a solid material and has a support element 22 aligned in the direction of a rear housing wall 21. A second bearing element 23 is fastened to a support element 22 and fixed in place with two retaining rings 24, 25. The second bearing element 23 is mounted on a support element 22 and mounted in a recess 26 of the gearbox 4. The support element 22 projects into the recess 26 here. In the example that is shown, the rear housing wall 21 is not completely closed, but instead has a through-hole that is closed up by the cap 27 that can be pressed in.

The second bearing element 23 has substantially smaller dimensions than the first bearing element 15 and merely serves to accommodate tilting forces that arise so that a vertical position of the running wheel 14 is maintained.

The special advantage of this embodiment is that a single first bearing element 15 can be used and only has to have sufficient dimensions to accommodate the corresponding loads. The second bearing element 23, in contrast, is not intended to be used to accommodate loads, but instead merely to accommodate tilting forces that may arise, and can have correspondingly smaller dimensions, so substantial costs can be saved.

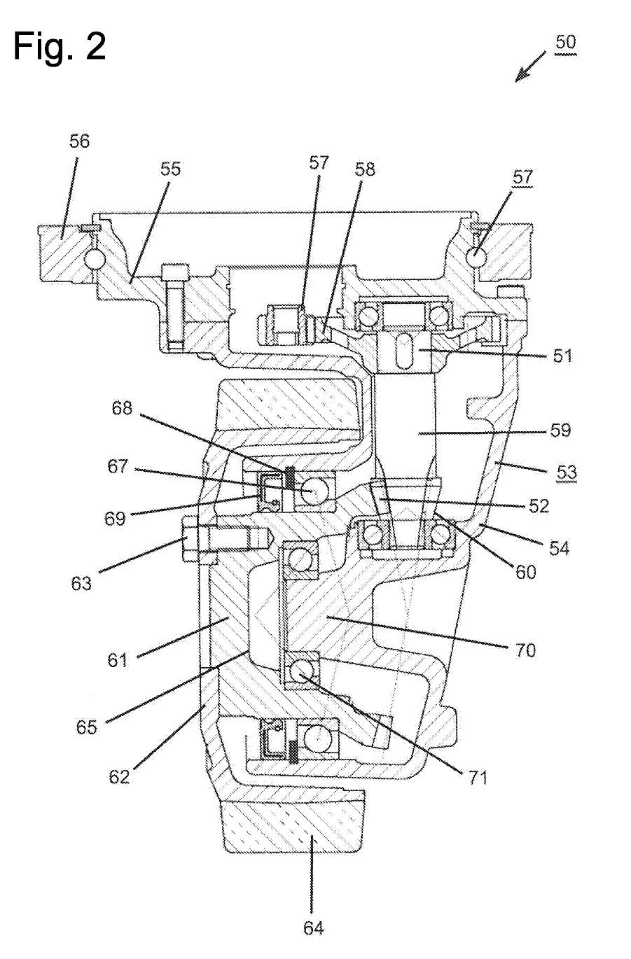

FIG. 2 shows, in a cutaway side view, a second drive unit 50 that likewise has two gear stages 51, 52. The two gear stages 51, 52 are installed in a gearbox 53 that has a completely closed rear housing wall 54 in this design variant. The gearbox 53 is closed up with a gearbox cover in the upper area that is in turn designed in the form of an inner ring 55 of the turntable bearing and consequently constitutes, together with the outer ring 56 of the turntable bearing, a turntable bearing. The first gear stage 51 has the same structure as the first example and is comprised of a driving pinion 57 that is mounted on the shaft of an electric motor, not shown, and that meshes with a spur gear 59. The spur gear 58 is mounted on a shaft 59 that is equipped on the opposite end with a spiral gearing 60, which in turn meshes with a bevel gear 61. The bevel gear 61 serves to fasten a running wheel carrier 62, which is fastened with the aid of screw bolts 63. The running wheel carrier 62 serves to mount a running wheel 64. The bevel gear 61 is designed with a pot shape with respect to the first example and has a recess 65 into which a support element 66 of the rear housing wall 54 of the gearbox 53 projects.

The bevel gear 61 is supported with respect to the gearbox 53 via a first bearing element 67; the bearing element 67 is in turn fixed in place with a retaining ring 68 and sealed with a sealing element 69. The sealing element 69 seals off the entire gearbox 53 in connection with this; access exists to the gearbox 53 to disassemble or assemble the gear stages after removal of the running wheel carrier 62 with the running wheel 64. The gearbox 53 is provided in this special case with a one-piece rear wall and has a support element 70 that projects into the recess 65 of the bevel gear 61. A second bearing element 71 that is supported on the bevel gear 61 is mounted on the support element 70, which is in a one-piece design with the rear housing wall. Tilting forces are in turn cushioned via the second bearing element 71, so the running wheel 64 remains in a horizontal position. The first bearing element 67 accommodates all of the loads, whereas the second bearing element 71 is merely provided to safeguard tilting forces.

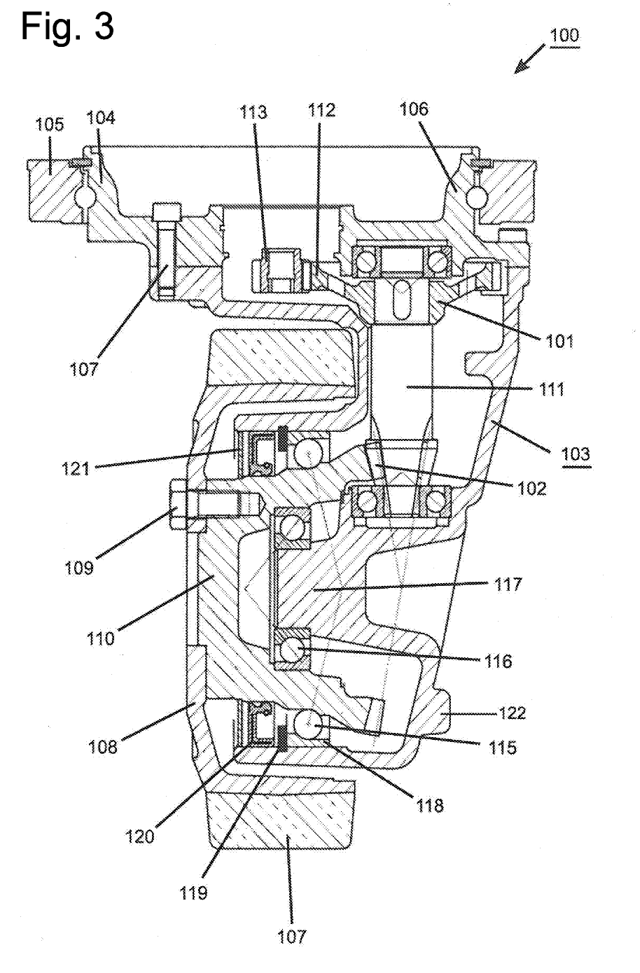

FIG. 3 shows, in a cutaway side view, a drive unit 100 with a first gear stage 101 and a second gear stage 102. The two gear stages 101, 102 are mounted in a gearbox 103, which is connected via a turntable bearing 104 to an industrial transport vehicle that is not shown. The turntable outer bearing 105 is connected to the industrial transport vehicle here, whereas the inner ring 106 of the turntable bearing is simultaneously designed in the form of an upper housing cover of the gearbox 103. The inner ring 106 of the turntable bearing, also the housing cover, is connected to the other housing parts via screw bolts 107. The gearbox 103 serves to accommodate a running wheel 108 here, which is connected via a running wheel carrier 109 to a bevel gear 110 with screw bolts 114. The bevel gear 110 is part of the second gear stage 102 and meshes with a spiral gearing of the drive shaft 111. The drive shaft 111 has a spur gear 112 at one end, which can be driven by a pinion 113 of an electric motor that is not shown. The bevel gear 110 is supported with respect to the gearbox 103 via a first bearing element 115 in this design variant. Tilting forces that arise are cushioned via a second bearing element 116 and passed to the gearbox 103. In this design, the bevel gear 110 has a pot shape and this consequently makes a coaxial arrangement of a support element 117 possible, which is formed in one piece on the rear housing wall 122 in the form of a gearbox 103. The support element is arranged in coaxial fashion with respect to the first and second bearing elements 115, 116 and the running wheel 108. The second bearing element 116 is mounted with its inner race on the support element 117 and supports the bevel gear 110 with the outer race. The position of the second bearing element 116 has been chosen in such a way in this case that it is within the width of the running wheel 108. The bevel gear 110 is supported with respect to the gearbox 103 by the first bearing element 115; the first bearing element 115 is comprised of an outer bearing shell 118 without the use of an inner bearing shell and, instead of that, a bearing surface is formed on the outside of the bevel gear 110. The outer bearing shell is fixed in place in the gearbox 103 with a retaining ring 119. Both the retaining ring 119 and the first bearing element 115 are sealed up with a sealing ring 120. After removing the running wheel 108, the possibility exists because of these construction measures to carry out the further disassembly of the two gear stages from one side of the gearbox 103. The sealing ring 120 is further protected by a protective ring 121.

### LIST OF REFERENCE NUMERALS

1 Drive unit

2 Gear stage

3 Gear stage

4 Gearbox

5 Turntable bearing

6 Inner ring of the turntable bearing

7 Outer ring of the turntable bearing

8 Pinion

9 Spur gear

10 Shaft

11 Spiral gearing

12 Bevel gear

13 Running wheel carrier

14 Running wheel

15 Bearing element

16 Retaining ring

17 Sealing element

18 Protective ring

19 Screw bolt

20 Screw bolt

21 Rear housing wall

22 Support element

23 Bearing element

24 Retaining ring

25 Retaining ring

26 Recess

27 Cap

50 Drive unit

51 Gear stage

52 Gear stage

53 Gearbox

54 Rear housing wall

55 Inner ring of the turntable bearing

56 Outer ring of the turntable bearing

57 Driving pinion

58 Spur gear

59 Shaft

60 Spiral gearing

61 Bevel gear

62 Running wheel carrier

63 Screw bolt

64 Running wheel

65 Recess

66 Support element

67 Bearing element

68 Retaining ring

69 Sealing element

70 Support element

71 Bearing element

100 Drive unit

101 Gear stage

102 Gear stage

103 Gearbox

104 Turntable bearing

105 Turntable outer bearing

106 Inner ring of the turntable bearing

107 Screw bolt

108 Running wheel

109 Running wheel carrier

110 Bevel gear

111 Drive shaft

112 Spur gear

113 Pinion

114 Screw bolt

115 Bearing element

116 Bearing element

117 Support element

118 Bearing shell

119 Retaining ring

120 Sealing ring

121 Protective ring

122 Rear housing wall

1. A drive unit for an industrial transport vehicle, at least comprising a gearbox with at least one gear stage, a drive motor and a running wheel,
wherein
the running wheel is directly connected to a bevel gear on the output side, which passes the load to be supported via a first bearing element for accommodating the load into the gearbox through an outer bearing race and which is supported by a second bearing element for stabilization with respect to the gearbox.

2. The drive unit according to claim 1,
wherein
the gearbox has a rear housing wall that is diametrically turned away from the running wheel and that is designed to be completely closed and formed in a single piece, or that the gearbox has a rear housing wall diametrically turned away from the running wheel, wherein the gearbox is closed by the rear housing wall and a cap.

3. The drive unit according to claim 1,
wherein,
the bevel gear has a support element formed in one piece in the direction of a rear housing wall or that the bevel gear has an open recess in the direction of a rear housing wall.

4. The drive unit according to claim 1,
wherein
the gearbox has a support element formed in the direction of the running wheel or that the gearbox has a pot-shaped recess in the interior into which the bevel gear projects with a support element.

5. The drive unit according to claim 1,
wherein,
support elements and recesses are arranged coaxially with respect to one another and mesh with one another.

6. The drive unit according to claim 1,
wherein
the first bearing element has a coaxially internal arrangement with respect to the running wheel and is within the width of the running wheel.

7. The drive unit according to claim 1,
wherein
the first bearing element has an inner bearing shell and an outer bearing shell or that the first bearing element has an outer bearing shell, whereas an inner bearing shell is formed by a bearing surface of the bevel gear.

8. The drive unit according to claim 1,
wherein
an inner or outer bearing shell of the first bearing element is axially movable and can be fixed in place with a retaining ring or that the first bearing element can be fixed in place with a retaining ring.

9. The drive unit according to claim 1,
wherein
the first bearing element has a seal accessible from the running-wheel side.

10. The drive unit according to claim 1,
wherein
the second bearing element is mounted on a support element of the bevel gear and is mounted in a recess of the gearbox or that the second bearing element is mounted on a support element of the gearbox and is mounted in a recess of the bevel gear.

11. The drive unit according to claim 1,
wherein
the bevel gear is a ring gear.

12. The drive unit according to claim 1,
wherein
a first gear stage is comprised of a spur gear driven by a drive motor via a driving pinion, said spur gear transferring the torque via a drive shaft to a second gear stage, wherein the second gear stage is comprised of a second bevel gear and a spiral gearing of the drive shaft.

13. The drive unit according to claim 1,
wherein,
the running wheel is directly connected to the bevel gear on the output side, which meshes via gearing with a drive shaft and passes the load to be supported via the first bearing element for accommodating the load into the gearbox through an outer bearing race and which is supported by a second bearing element for stabilization with respect to the gearbox.

14. The drive unit according to one of claim 1,
wherein,
a drive shaft is supported by the bearing elements on the head side and/or that the drive unit is connected to the industrial transport vehicle via a turntable bearing.

15. The drive unit according to claim 1,
wherein,
the gearbox is connected to an inner ring of a turntable bearing.
